(19) United States
(12) Patent Application Publication
(10) Pub. No.: US 2026/0276425 A1
(43) Pub. Date: Sep. 17, 2026

(54) RECEPTACLE FILL LEVEL DETECTION

(71) Applicant: CareFusion 303, Inc., San Diego, CA (US)

(72) Inventors: Rebecca Weiss, San Diego, CA (US); Christian Thompson, San Diego, CA (US); Rachel Molloy, San Diego, CA (US)

(21) Appl. No.: 19/471,262

(22) PCT Filed: Apr. 4, 2023
(86) PCT No.: PCT/US2023/017476

§ 371 Date: Sep. 30, 2025

(51) Int. Cl. G01F 23/00

(52) U.S. Cl. CPC G01F 23/00

(57) ABSTRACT

A fill level detection assembly for determining a receptacle fill level. A bar, coupled by a hinge to an inner surface of an entry point of a receptacle is used to determine the receptacle fill level. The bar includes a platform at a distal edge of the bar. The platform is configured to come in contact with an item deposited in the housing. A sensor is configured to generate a signal indicative of a fill level of the housing based on the platform coming in contact with the item deposited in the housing.

### TECHNICAL FIELD

The subject matter described herein relates generally to mechanisms of depositing items into receptacles and more specifically to a telescoping bar configured for detection of a fill level of a receptacle.

### BACKGROUND

Receptacles that are designed for depositing items can be configured to prevent regular personnel from accessing an interior of the receptacles. The access limiting feature prevents regular users from knowing a fill level of a receptacle until the receptacle is completely filled. In many cases, receptacles can be filled by multiple personnel, at varying frequencies, and in different amounts, depending on different events occurring at the respective facility. The fluctuations in deposition of items in receptacles makes it difficult to predict a fill level of the receptacles. Completely filled receptacles, can make the receptacles unusable, before a scheduled emptying operation. If a receptacle is full, the personnel, who intended to deposit items in the full receptacle, would have to search for other options to deposit the items, which might include personally storing the items (e.g., in a pocket) during the downtime of the receptacle or would have to make an additional trip to a central return point. The urgency of depositing items in designated receptacles might be exacerbated if the items include high-value and/or controlled chemicals or materials, which would be illegal to be kept by regular users longer than a set amount of time.

### SUMMARY

Systems, apparatuses, and articles of manufacture, are provided for a receptacle fill level detection.

In one aspect, an apparatus includes: a housing, an entry point affixed to the housing, a bar, coupled by a hinge to an inner surface of the entry point, the bar including a platform at a distal edge of the bar, the platform being configured to come in contact with an item deposited in the housing, and a sensor configured to generate a signal indicative of a fill level of the housing based on the platform coming in contact with the item deposited in the housing.

In some variations, one or more features disclosed herein including the following features can optionally be included in any feasible combination. In some implementations, the entry point includes an item receiver configured to block an access to an interior of the housing, when the entry point is in an opened position, the item receiver being configured to release deposited items in the housing when the entry point is in a closed position. In some implementations, the hinge is configured to maintain the bar in a vertical position independent of a position of the entry point. In some implementations, the bar includes a plurality of segments that can slide relative to each other to adjust a length of the bar relative to the fill level of the housing. In some implementations, the plurality of segments includes a first segment having a first sliding resistance and a second segment having a second sliding resistance, the first sliding resistance being different from the second sliding resistance to enable sequential sliding of the plurality of segments. In some implementations, the bar includes a spring configured to adjust the length of the bar, for the bar to apply substantially zero pressure on the item the platform is in contact with. In some implementations, the sensor is configured to detect a length of the bar based on the position of the platform. In some implementations, the sensor includes an ultrasound sensor or an infrared sensor. In some implementations, the sensor is attached to a proximal end of the edge of the bar or to the hinge. In some implementations, the sensor is configured to generate a signal to block an opening of the entry point in response to detecting that the housing is full.

In another aspect, a method of detecting a fill level of a bin, the method including: receiving, from a sensor, a first measurement of a first length of a telescoping bar coupled to an entry point of the bin, detecting, opening of the entry point of the bin, permitting one or more items to be deposited into the bin, receiving from the sensor, a second measurement of a second length of the bar being in contact with the one or more items deposited into the bin, and determining the fill level based at least in part on a comparison between the first measurement and the second measurement.

In some variations, one or more features disclosed herein including the following features can optionally be included in any feasible combination. In some implementations, the sensor is activated to measure a length of the bar in response to a trigger associated with the opening of the entry point. In some implementations, the method includes: determining that the fill level exceeds a threshold fill level, and preventing an opening of the entry point of the bin by activating an entry point lock. In some implementations, the method includes: transmitting a request to empty the bin. In some implementations, the method includes: determining an emptying of the bin, and deactivating the entry point lock. In some implementations, the sensor includes an ultrasound sensor or an infrared sensor. In some implementations, the method includes: processing the first measurement and the second measurement received from the sensor to determine a percentage of the fill level of the bin. In some implementations, the method includes: displaying the fill level of the bin. In some implementations, the method includes: receiving an identifier of the one or more items to be deposited into the bin, determining an estimated fill level of the bin based on the identifier of the one or more items, and adjusting the determined fill level of the bin based on the estimated fill level of the bin. In some implementations, the method includes: generating a signal to retract the bar in response to receiving any of the first measurement and the second measurement.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a system for detection of a receptacle fill level having a fill level detection assembly, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a diagram illustrating an example of a system for detection of a receptacle fill level, in accordance with some example implementations;

FIG. 2 depicts a diagram illustrating a portion of the example of the system for detection of a receptacle fill level shown in FIG. 1, in accordance with some example implementations;

FIGS. 3A-3F and 4A-4F depict views of examples of a receptacle with fill level detection assembly that is progressively filling, in accordance with some example implementations;

FIG. 5 depicts an example process, in accordance with some example implementations;

FIG. 6 depicts a block diagram illustrating an example of a computing system, in accordance with some example implementations;

When practical, similar reference numbers denote similar structures, features, or elements.

### DETAILED DESCRIPTION

Implementations of the present disclosure are generally directed to detection and monitoring of a fill level of a receptacle used for depositing items. More particularly, implementations of the present disclosure are directed to a fill level detection assembly for a receptacle that includes a telescoping bar and a sensor. The telescoping bar can be attached internally within the receptacle to track the fullness level as items are added. The telescoping bar includes a platform at a distal edge. The platform is configured to come in contact with an item deposited in the housing, triggering an adjustment of a length of the telescoping bar in response to a change in a fill level of the receptacle. The sensor can generate a signal indicative of a fill level of the housing based on the platform coming in contact with the item deposited in the housing.

Automatic detection and real-time tracking of fill levels of receptacles (without human intervention) can enable optimization of an emptying schedule of the receptacles to prevent the receptacle to become completely full and therefore unusable, or at least to minimize a time period the receptacles are unusable. By detecting the fill level of the receptacles to maintain them within usable ranges, the fill level tracking system prevents delays with item deposition, preventing such delays to interfere with a schedule of a receptacle user. Another advantage of the receptacle fill level detection assembly is that the telescoping bar is configured to automatically adjust its length in response to the receptacle being emptied, triggering a reset of a fill level of the receptacle to indicate that the receptacle is empty. Accordingly, the fill level detection assembly described herein may enable an accurate automatic detection and real-time monitoring of fill levels of receptacles.

Implementations of the present disclosure are described in view of an example context. The example context includes automatic detection and real-time monitoring of fill levels of receptacles located within medical facilities. Within the example context the receptacles can be used, by receptacle users, for depositing (or dispensing of) medical items, including regulated medication conditioned to be returned to a pharmacy within a set time interval. The fill level monitoring system can enable receptacle users to deposit items in available receptacles with a fill level below a set threshold. In the context of a medication management system, only assigned receptacle users (‘receptacle controllers’) are permitted to access the contents in the return receptacle and re-process medications that have been returned. The fill level monitoring system can process receptacle data collected by the fill level detection assembly to prompt receptacle controllers to empty the receptacle at appropriate intervals. Adjustment of emptying schedule based on receptacle fill levels can prevent the receptacles within a medical facility from becoming full and therefore unusable for the health care providers, enabling compliance with return medications policies.

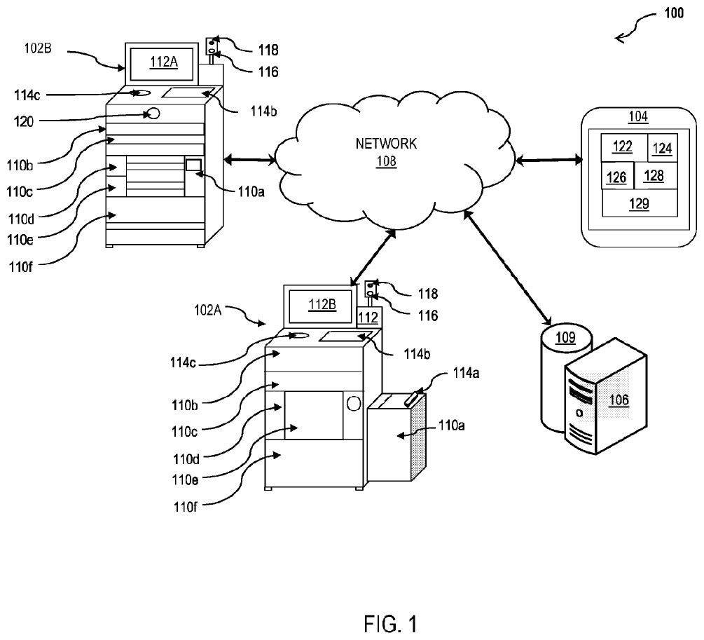

FIG. 1 illustrates a simplified example of a system 100 for detection and real-time tracking of fill levels of receptacles. The example system 100 includes a first depositing system 102A, a second depositing system 102B, a user device 104, a data processing system 106, and a network 108.

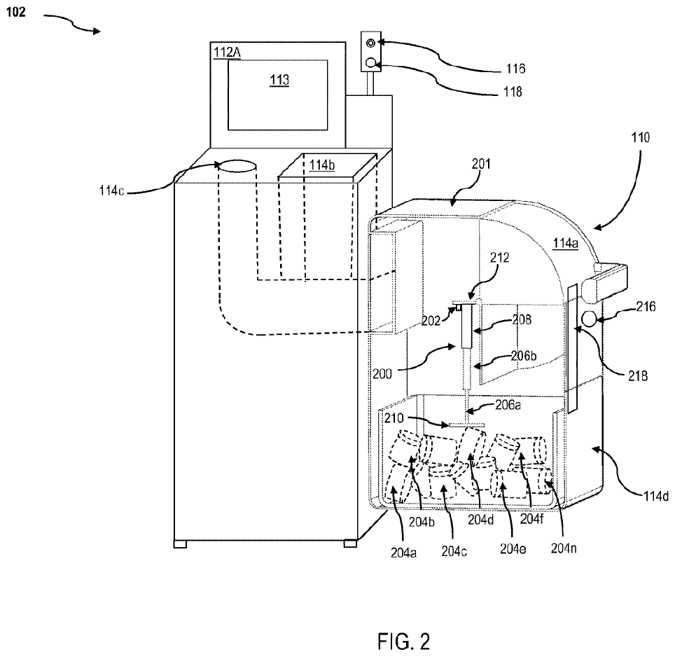

Each depositing system 102A, 102B can be provided as an item depositing system that enables tracking of receptacle fill levels, and the like. Although two depositing systems 102A, 102B are illustrated, implementations of the present disclosure can include more depositing systems. Some instances of the depositing system 102A, 102B may be configured as automated medication dispensing cabinets including features similar to, for example, a BD Pyxis MedStation™ from Becton, Dickinson and Company. The depositing systems 102A, 102B can include one or more receptacles 110a-110f, a fill level tracking device 112A, 112B, one or more entry points 114a, 114b, 114c, one or more sensing devices 116, 118, and a smart lock 120. For example, the depositing systems 102A, 102B can include one or more receptacles 110a-110f that are being monitored, by a respective fill level tracking device 112A, 112B, to track the fill level of each individual receptacle 110a-110f, using a telescopic bar as described with reference to FIGS. 2, 3A-3F and 4A-4F, and 5. In the example system 100 illustrated in FIG. 1, the first depositing system 102A, and the second depositing system 102B include a plurality of receptacles 110a that could each be configured to securely receive items, when the fill level is below a set threshold (receptacle is not full) and to store the deposited items until the receptacle 110a-110f is emptied by assigned users (receptacle controllers).

The receptacles 110a-110f, can have different shapes and sizes, without being limited to the example arrangement illustrated in FIGS. 1-3. The receptacles 110a-110f can include drawers and/or bins. The receptacles 110a-110f may include one or more drawers. The receptacles 110a-110f may include audit receptacles, for example, receptacles of highly controlled substances. The receptacles 110a-110f may each include passages to an interior of a particular receptacle in a way that optimizes detection of fill level the receptacle (e.g., from a direction that would generate a trigger of a sensor detecting a change in fill level). The receptacles 110a-110f can be configured for depositing items in bulk, such as multiple items (medication stored in multiple containers). The arrangement, as shown in FIGS. 1 and 2, allows for the collection of different types of items in receptacles 110a-110f for auditing the deposited items. Moreover, the receptacle arrangement as shown in FIGS. 1 and 2 allows for the items not selected for audit to be collected in the bulk receptacles. In some implementations, the depositing systems 102A, 102B are located at the same facility or at different facilities. In the case of multiple facilities, the facilities can be remotely located from one another, and/or can be located at a common location, or site (e.g., separate departments in a common (the same) building). Each of the receptacles 110a-110f can include a fill level detection assembly configured to monitor a fill level of the respective receptacle 110a-110f, as described with detail to FIGS. 2 and 3A-3F and 4A-4F.

The fill level tracking devices 112A, 112B can be configured to determine, display, and transmit receptacle fill level data associated with the receptacles 110a-110f of each of the first and second depositing systems 102A, 102B. For example, the fill level tracking devices 112A, 112B can transmit receptacle fill level data, over the network 108 to the data processing system 106 for processing and to the user device 104 or any other user device for presentation or display. Each depositing system 102A, 102B includes a (computing) fill level tracking device 112A, 112B to guide a user through the depositing process, including, for example, authenticating the user, labeling and/or securing the deposited item, and/or depositing the item in a corresponding receptacle through the entry point 114 (e.g., a first item type general receiver 114a or a second item type general receiver 114b or an entry mechanisms 114c of a respective receptacle 110a) of the depositing system 102A, 102B. The fill level tracking devices 112A, 112B can include any number of example processing devices, such as, but not limited to, a computing device. The fill level tracking devices 112A, 112B can include a display, a processor, memory, and a user interface (including an input interface and a communication interface). The user interface 113 can display prompts on the display and/or accept inputs from a user to guide the user through the depositing process, thereby confirming each step is complete, secure, and auditable. The fill level tracking device 112A, 112B integrated in the depositing system 102A, 102B may provide visual feedback based on images captured by the camera 118. The visual feedback may allow the user to verify that the depositing system 102A, 102B has a clear image of the item being deposited in selected receptacles 110a-110f that are detected as not being full.

The sensing devices 116, 118 can include at least one of the following: a camera, a motion sensor, an image capturing device, a scanner, a QR code scanner, a keypad sensing device, and any combination thereof. The depositing system 102A, 102B may be equipped with one or more sensing devices 116, 118 that can be configured to detect, receive, read, etc. various data that can be presented to them. The data can include an authentication data that can be associated with a particular user (e.g., a QR (quick response) code, a PIN (Personal Identification Number) code, etc.). In some implementations, the detection of the user authentication data includes scanning, using at least one sensing device 116, 118 positioned on the depositing system 102A, 102B, for the authentication data. The authentication data can be transmitted by sensing devices 116, 118 to the fill level tracking devices 112A, 112B to process the authentication data.

The user device 104 can include any number of example devices. Such example devices include, but are not limited to, a mobile phone, a smartphone, a tablet computing device, a personal digital assistant (PDA), a laptop personal computer (PC), a desktop PC, and/or appropriate combinations thereof. In the depicted example, the user device 104 includes a display 122, a processor 124, memory 126, an input interface 128, and a communication interface 129. The processor 124 can process instructions for execution of implementations of the present disclosure. The instructions can include, but are not limited to, instructions stored in the memory 126 to display graphical information on the display 122. Example displays include, but are not limited to, a thin-film-transistor (TFT) liquid crystal display (LCD), or an organic light emitting diode (OLED) display. The memory 126 stores information within the user device 104. In some implementations, the memory 126 can include a volatile memory unit or units, and/or a non-volatile memory unit or units. In other implementations, removable memory can be provided, and can include, but is not limited to, a memory card. Example memory cards can include, but are not limited to, a secure digital (SD) memory card, a mini-Secure Digital (SD) memory card, a Universal Serial Bus (USB) stick, and the like. In some implementations, the input user interface 113, 128 can include a keyboard, a touchscreen, a mouse, a trackball, a microphone, a touchpad, and/or appropriate combinations thereof. In some implementations, an audio codec (not shown) can be provided, which receives audible input from a user or other source through a microphone, and converts the audible input to usable digital information. The audio codec can generate audible sound, such as through a speaker that is provided with the user device 104. Example sounds can include sound from voice telephone calls, recorded sound (e.g., voice messages, music files, etc.), and/or sound generated by applications operating on the user device 104. Although a single user device 104 is illustrated, it is contemplated that one or more user devices 104 can communicate with each of the first and second depositing systems 102A, 102B through the network 108. Communication between the user device 104, the level tracking device 112A, 112B and the data processing system 106 can be achieved via a direct connection, or remotely through the network 108. For example, the user device 104, and the depositing systems 102A, 102B can communicate over the network 108 through a respective connectivity interface(s).

The data processing system 106 can be provided as a server (e.g., a computing device including one or more central processing units, graphical processing units, and/or the like), such as a front-end server, a back-end server, a cloud server, a group of servers, and/or other like devices. The data processing system 106 can include and/or be coupled to a database 109 to support the acquisition, storage, modification, and distribution of receptacle fill level information, such as receptacle fill levels, throughout the example system 100 of the facility including the depositing systems 102A, 102B. The database 109 stores data that is transmitted to, received from, and/or updated by the depositing systems 102A, 102B and the user device 104. In some examples, database 109 includes a storage component that stores data and/or software related to the operation of the depositing systems 102A, 102B including the fill level of receptacles 110a-110f detected and transmitted by the level tracking device 112A, 112B of the depositing systems 102A, 102B. In some implementations, the database 109 stores data detected by the sensing devices 116, 118, associated with detected and authenticated users of the depositing systems 102A, 102B. In some embodiments, database 109 can be implemented across a plurality of devices. For example, the database 109 can be included in the data processing system 106, the user device 104, the depositing systems 102A, 102B, and/or the like.

Although the example system 100 includes a data processing system 106 located remotely from the depositing systems 102A, 102B, it is contemplated that the data processing system 106 can be integrated within one or more of the depositing systems 102A, 102B. Further, data can be transferred between the data processing system 106 and each of the first and second depositing systems 102A, 102B through the network 108.

The network 108 can include a satellite receiver, cellular network, a Bluetooth system, a Wi-Fi system (e.g., 802.x), a cable modem, a DSL/dial-up interface, a private branch exchange (PBX) system, and/or appropriate combinations thereof. Each of these connectivity interfaces enables data to be transmitted to/from the network 108. In some implementations, the network 108 can be provided as a local area network (LAN), a wide area network (WAN), a wireless LAN (WLAN), a metropolitan area network (MAN), a personal area network (PAN), the Internet, and/or combinations thereof.

With continued reference to FIG. 1, the number and arrangement of the components and/or devices of the example system 100, shown in FIG. 1 are provided as an example. There may be additional systems and/or devices, fewer systems and/or devices, different systems and/or device, or differently arrangement systems and/or devices than those shown in FIG. 1. Furthermore, two or more systems and/or devices show in FIG. 1 may be implemented within a single system or a single device, or a single system or a single device shown in FIG. 1 may be implemented as multiple, distributed systems or devices. Additionally, or alternatively, a set of systems or a set of devices (e.g., one or more systems, one or more devices) of the example system 100 may perform one or more functions described as being performed by another set of systems or another set of devices of the example system 100. The example system 100 can be configured to limit and control access to particular portions of the depositing systems 102A, 102B to authorized users based on tracked fill levels of the receptacles 110a-110f. For example, authorized users can be authenticated to access a depositing point 114 to deposit an item in a selected receptacle of the receptacles 110a-110f. Some assigned users (receptacle controllers) can be authenticated to empty filled receptacles 110a-110f. For example, the depositing systems 102A, 102B can be configured to control unlocking/locking of one or more features (e.g., entry port, emptying port, doors, rotating ramps, smart lock, etc.) of the receptacles 110a-110f and/or to control execution of an operation (e.g., receptacle empty operation) of the receptacles 110a-110f. One or more functions performed by the example system 100 are described with reference to FIGS. 2-4.

Referring now FIG. 2, implementations of the present disclosure provide a depositing system 102 configured to track a fill level of a receptacle 110, using a bar 200. The receptacle 110 can include a housing 201 attached to an exterior wall of the depositing system 102, as illustrated in FIG. 2, or can be within the depositing system 102, as illustrated in FIG. 1. The receptacle 110 can include a bar 200 and one or more sensors 202 used to detect a fill level of the receptacle 110.

The bar 200 can be made of an inelastic light weight material (e.g., fiberglass, plastic, or plexiglass), from metal (e.g., stainless steel), or any other types of materials that do not break or bend when coming in contact with deposited items 204a-204n. The bar 200 can include a series of telescoping sections. The bar 200 can include an arm including multiple sections 206a, 206b, 208, a platform 210, and a hinge 212. The variable length sections 206a, 206b and, optionally, a fixed length section 208 can be configured to adjust an adjustable feature (length) of the bar 200, in response to a change in a fill level of the receptacle 110. The variable length sections 206a, 206b can retract by becoming shorter as the receptacle fill level increases. The variable length sections 206a, 206b can be configured to automatically extend to a respective maximum length after the receptacle 110 is emptied, the respective maximum length corresponding to a length for which a distal edge of the bar 200 is in contact with a bottom inner surface of the receptacle 110. The variable length sections 206a, 206b of the bar 200 can include a telescoping bar, a spring, and/or a telescopic spring. In some implementations, a first variable length section 206a (e.g., a distal variable length section) can include a first resistive element (e.g., spring) and a second variable length section 206b (e.g., a distal variable length section) can include a second resistive element (e.g., spring) with a higher sliding resistance (lower compressive elasticity) than the first resistive element, such that the length of the variable length sections 206a, 206b is sequentially adjusted. For example, as the receptacle 110 fills with items 204a-204n, the first variable length section 206a decreases to a minimum value (e.g., approximately zero), after which the second variable length section 206b decreases to a minimum value (e.g., approximately zero). The first variable length section 206a (e.g., a distal variable length section) can include the platform 210 at a distal edge coinciding with a distal edge of the bar 200. The bar 200 can be configured such that the platform 210 applies approximately zero pressure on the deposited items 204a-204n. The platform 210 can include a circular or quadrilateral horizontal cross section. The platform 210 can be configured to have a horizontal surface with an area smaller than the area of the inner surface of the receptacle 110 and, optionally, smaller than the area of designated items 204a-204n expected to be deposited, to prevent deposited items 204a-204n from remaining on top of the platform. The platform 210 (e.g., bottom surface of the platform) can be configured to come in contact with an item 204a-204n deposited in the housing. The hinge 212 can couple a proximal edge of the bar 200 to an inner surface of the housing 201 of the receptacle 110, such as a portion of an entry point 114a (e.g., door) or a top inner horizontal surface (ceiling) of the housing 201 of the receptacle 110. The hinge 212 can include a bracket or plate and a mounting feature, such as a bolt or a mounting pin (not shown) for (releasable or permanent) attachment of the bar 200 to the inner surface of the housing 201 of the receptacle 110.

The sensor 202 can include one or more sensors or a sensory array. The sensor 202 can attach to the hinge 212 and/or an inner surface of the receptacle 110. The sensor 202 can be configured to detect a location of one or more points of the telescoping bar 200 (e.g., a distal end of the telescoping bar 200, such as a position of the platform 210) or the location of the entire bar 200, indicative of a length of the bar 200. The sensor 202 can include an ultrasound sensor, an infrared sensor, a gyroscope, a pressure sensor, a camera, a magnetic sensor, a radio frequency sensor, a light sensor, a force sensor, a pressure sensor, or the like. The sensor 202 can detect the signals associated with filling level of a respective receptacle 110 continuously and/or at various time intervals (e.g., every 10 seconds, 30 seconds, 1 minute, 30 minutes, 1 hour, 12 hours, 24 hours, and the like). In some implementations, sensor 202 can detect the signals associated with filling level of a respective receptacle 110 after an activation of an entry mechanism 114a or of an emptying port 114d, to detect a change in the length of the bar 200 based on a change in receptacle fill level (after deposition of items 204a-204n within the receptacle 110 through the entry mechanism 114c). The sensor 202 can be configured to generate signals indicative of a receptacle fill level (length or position of the telescoping bar 200) and transmit them to a controller 218 of the fill level tracking device 112A. The fill level tracking device 112A can process signals received from the sensor 202 to determine, based at least on the length of the bar 200 and the fill level of the receptacle 110 to activate the controller 218 to selectively open or close the entry mechanism 114a or the emptying port 114d. The fill level tracking device 112A can be configured to transmit the fill level of the receptacle to the user interface 113 and/or an indicator 216 to display the fill level of the receptacle 110. The controller 218 can be coupled with the indicator 216 (e.g., LED lights, software) to relay the fullness level of the receptacle 110 to potential receptacle users and/or the status (opened or closed) of the entry mechanism 114a or the emptying port 114d. In some implementations, the indicator 216 can use a color code to indicate the fullness level of the receptacle 110 (e.g., green color indicating that the receptacle includes at least a minimum empty volume for depositing additional items 204a-204n, orange color indicating that the receptacle includes limited empty volume for depositing additional items 204a-204n, and red color indicating that the receptacle is full and includes insufficient empty volume for depositing additional items 204a-204n). The controller 218 can be physically coupled to the receptacle 110 or it can be positioned at a location separate from the receptacle 110 (e.g., proximal to the input user interface 113).

A fill level of the receptacle 110 can be tracked based on the controlled deposition of an item 204a through an entry point 114a, 114b, 114c or evacuation of previously deposited items 204a-204n through the emptying port 114d. The access to any of the entry point 114a, 114b, 114c and/or emptying port 114d can be controlled, by the level tracking device 112A of the depositing systems 102A, in response to processing authentication data received from the sensing devices 116, 118. The access to any of the entry point 114a, 114b, 114c and/or emptying port 114d can be controlled, by the level tracking device 112A of the depositing systems 102A, in response to processing fill level data received from one or more sensor 202 detecting a feature (length) of the bar 200. For example, access to an entry point 114a, 114b, 114c can be provided, to successfully authenticated users, if the fill level of the receptacle 110 is below a critical fill level threshold or the access to any entry point 114a, 114b, 114c can be prevented (access points can be blocked) is user authentication fails or if the fill level of the receptacle 110 is above the critical fill level threshold. In some implementations, in response to providing an access to an entry point 114a, 114b, 114c and/or emptying port 114d, the bar 200 can be automatically retracted to a minimum bar length and after the respective entry point 114a, 114b, 114c or emptying port 114d is closed, the bar 200 is allowed to extend (from gravity with the internal spring control) until the platform 210 comes in contact with a top portion of deposited items 204a-204n and/or bottom of the receptacle 110, if the receptacle was emptied. In view of this context, the present disclosure provides integrated visibility of detected fill levels of receptacles 112 to enable real-time adjustment of receptacle emptying schedule. It is appreciated, however, that implementations of the present disclosure are readily applicable in other contexts with other forms of automatic detection and real-time tracking of fill levels of receptacles 112 using the length adjustable bar 200.

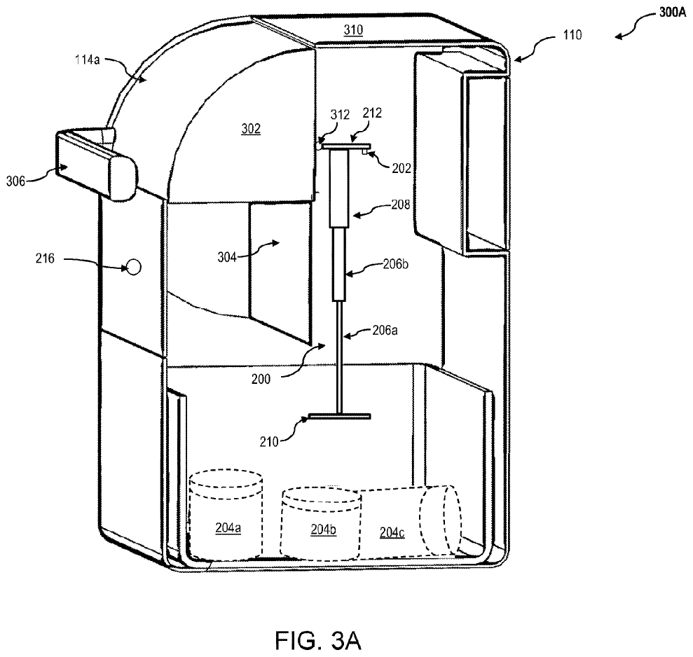

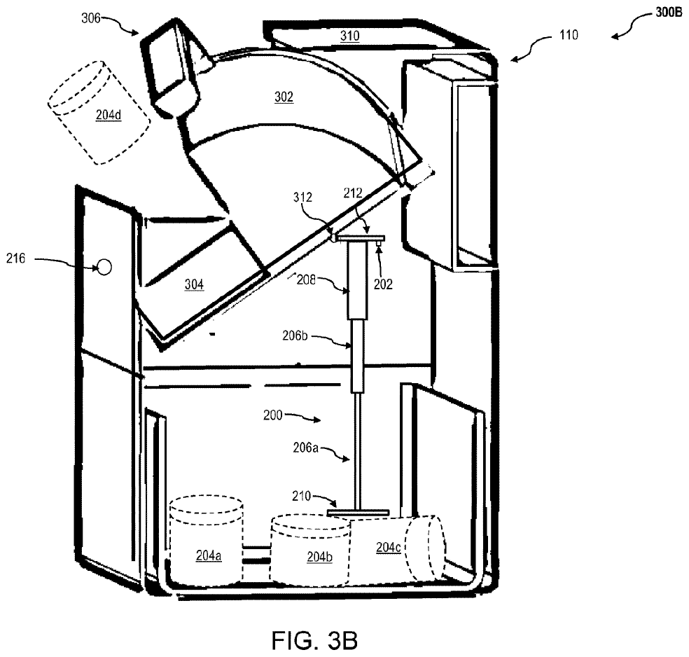

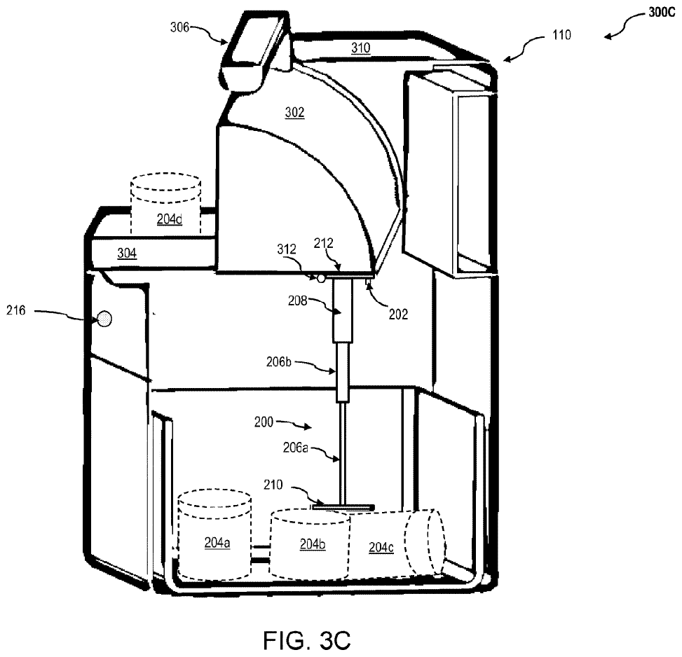

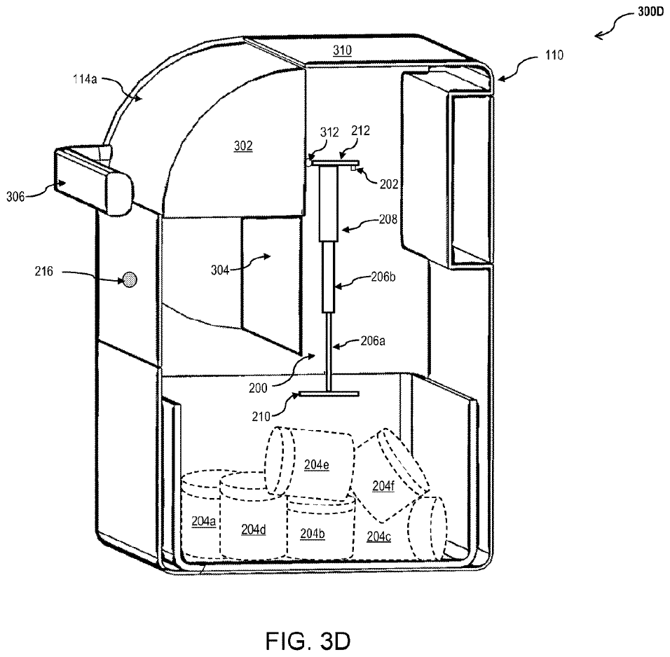

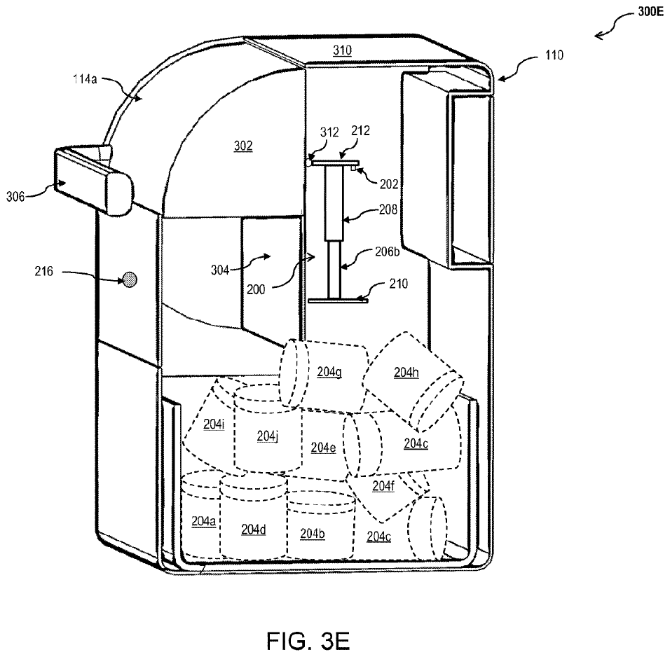

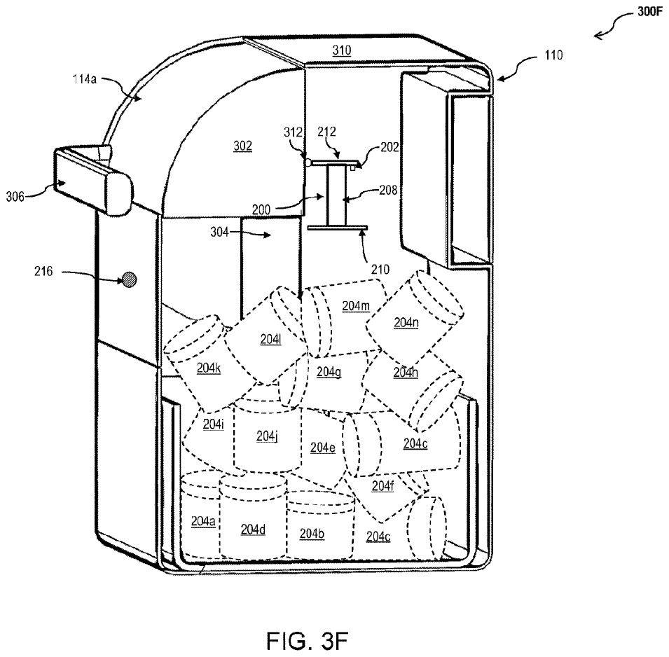

FIGS. 3A-3F schematically depict vertical sectional views 300A, 300B, 300C, 300D, 300E, 300F of the receptacle 110 configured to monitor a filling level during deposition of items 202a-202n, consistent with implementations of the current subject matter. The three-dimensional cross-sectional views 300A, 300B, 300C, 300D, 300E, 300F of the receptacle 110 indicate examples of accessing an entry point 114a and uses of the bar 200 to determine a fill level of the receptacle being filled with different amount of items 202a-202n. In the illustrated examples of the three-dimensional cross-sectional views 300A, 300B, 300C, 300D, 300E, 300F of the receptacle 110, the entry point 114a is shown as being closed in FIGS. 3A and 3D, partly opened in FIG. 3B, and completely opened in FIG. 3C. The entry point 114a includes a cover 302, an item receiver 304, and, optionally, a handle 306. The cover 302 can have a curved surface configured to cover a top portion of the receptacle 110, while the receptacle 110 is closed, as shown in FIGS. 3A, 3D, 3E and 3F. At least a portion of the cover 302 can revolve underneath a static portion 310 of a top horizontal surface of the receptacle 110 in conjunction with the item receiver 304, for example in response to the handle 306 being pushed upwards, as illustrated in FIGS. 3B and 3C. The item receiver 304 can include a flat portion that is in a vertical position within the receptacle 110 when the entry point 114a is closed and in a horizontal position that is accessible to a user when the entry point 114a is opened. The item receiver 304 can be configured as a barrier having characteristics (shape and dimensions) matching an opening that would be formed by the opened entry point 114a if the item receiver would be missing, such that the item receiver 304 completely covers any potential access to an inner space of the receptacle 110 while the entry point 114a is partially or completely opened. The handle 306 can be attached to the cover 302 to enable opening and closing of the entry point 114a. The entry point 114a or any portion of the entry point 114a, such as the cover 302, the item receiver 304, and, optionally, the handle 306 can be formed of a durable (impact resistant) material, such as a polymer, a metal, an alloy, or a metallic compound.

The bar 200 can be attached, by a hinge 212, using a ball bearing 312, to a portion of the receptacle 110, for example, as illustrated in FIGS. 3A-3F to the back of the entry point 114a. The hinge 212 including the ball bearing 312 can enable the bar 200 to remain in a vertical position independent of the opening state of the entry point 114a. The bar 200 has a length adjustment mechanism to vary the length to detect an amount of items 202a-202n deposited in the receptacle 110.

The length adjustment mechanism illustrated in FIGS. 3A-3F configures the bar 200 to have a length adjustable in response to opening the entry point 114a. FIGS. 3A and 3D-3F, illustrate the configuration of the bar 200 when the entry point 114 is closed and the receptacle is filled with different amount of items 204a-204c. The length adjustment mechanism illustrated in FIGS. 3A and 3D-3F configures the bar 200 to have a length, at which the platform 210 is above (contactless with) any item 204a-204j deposited in the receptacle 110 when the entry point 114 is closed. The length adjustment mechanism illustrated in FIGS. 3B and 3C swings the bar 200 when the entry point 114 is opened, such that the platform 210 comes in contact with a top item 204a-204j deposited in the receptacle 110, applying a force on the bottom surface of the platform 210 that triggers an adjustment of the length of the bar 200. The closure of the entry point 114 elevates the bar 200, such that the platform 210 is moved away from the items 204a-204j deposited in the receptacle 110. The length adjustment mechanism illustrated in FIGS. 3A-3F includes an adjustment of the length of the bar 200 through a repetitive process until the receptacle 110 gets to a particular fill point (e.g., 90% full) corresponding to a set length of the bar 200.

FIG. 3A illustrates the first variable length section 206a as being fully extended and the second variable length section 206b of the bar 200 as being fully extended, such that the platform 210 is contactless above all items 204a-204c deposited in the receptacle 110. The sensor 202 can detect the position of the platform 210 indicating that the first variable length section 206a is fully extended and the second variable length section 206b of the bar 200 is fully extended indicating that the entry point 114 was not reopened after items 204a-204c were deposited in the receptacle 110.

FIGS. 3B and 3C illustrate the opening of the entry point 114, which moves the bar 200 downwards to come in contact with one or more top items 204b, 204c previously deposited in the receptacle 110. The downward shift of the bar 200 in combination with the interaction of the platform 210 with one or more top items 204b, 204c generates a force on the surface of the platform 210 that triggers an adjustment of the length of the bar 200. The adjusted length of the bar 200, as illustrated by FIGS. 3B and 3C, includes the first variable length section 206a as being partly retracted and the second variable length section 206b of the bar 200 as being fully extended.

FIGS. 3C and 3D illustrate a length of the bar 200 that remains constant after the closure of the entry point 114. FIG. 3D illustrates the bar 200 having a second length corresponding to the second amount of items 202a-202c, being shorter than the first length corresponding to a previous measurement (e.g., empty receptacle 110), as illustrated in FIG. 3A. FIG. 3D illustrates the first variable length section 206a as being partly retracted and the second variable length section 206b of the bar 200 as being fully extended, such that the platform 210 is in contact with a top located item 204e deposited in the receptacle 110. The sensor 202 can detect the position of the platform 210 indicating that the first variable length section 206a is partly retracted and the second variable length section 206b of the bar 200 is fully extended, corresponding to a partly filled (e.g., 15% filled) receptacle 110.

FIGS. 3D to 3E illustrate an increasing amount of items deposited in the receptacle 110 from the second amount of items 202a-202f to a third amount of items 202a-202j. FIG. 3E illustrates the bar 200 having a third length corresponding to the second amount of items 202a-202f being shorter than the second length corresponding to the first amount of items 202a-202c. FIG. 3E illustrates the first variable length section 206a as being fully retracted and the second variable length section 206b of the bar 200 fully extended, such that the platform 210 is in contact with a top located item 204q deposited in the receptacle 110. The sensor 202 can detect the position of the platform 210 indicating that the first variable length section 206a is fully retracted and the second variable length section 206b of the bar 200 is fully or partly extended, corresponding to a partly filled (e.g., 70% filled) receptacle 110.

FIGS. 3E to 3F illustrate an increasing amount of items from deposited in the receptacle 110 from the third amount of items 202a-202j to a fourth amount of items 202a-202n. FIG. 3F illustrates the bar 200 having a fourth length corresponding to the third amount of items 202a-202i being shorter than the third length corresponding to the second amount of items 202a-202f. FIG. 3F illustrates the first and second variable length sections 206a, 206b as being fully retracted, such that the platform 210 is above a top located item 204n deposited in the receptacle 110. The sensor 202 can detect the position of the platform 210 indicating that the variable length sections 206a, 206b are fully retracted, corresponding to a maximum fill level of the receptacle 110.

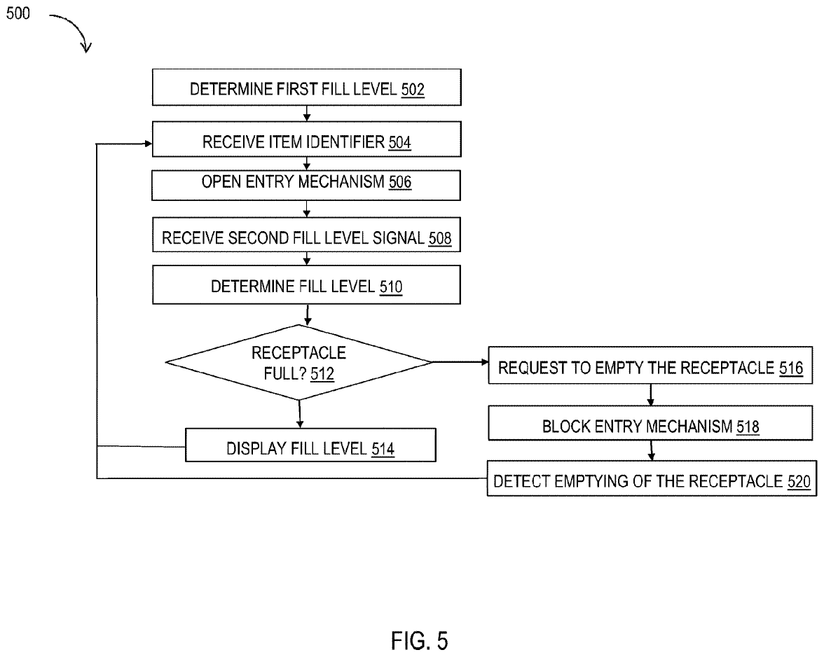

FIGS. 3A-3D illustrate examples of three-dimensional cross-sectional views 300A-300D with different receptacle fill levels that provide at least a minimum empty volume within the receptacle 110 to enable deposition of additional items. For the examples illustrated in FIGS. 3A-3E the sensor 202 can detect that the telescoping bar 200 has a particular length that is greater than a threshold length and/or the platform 210 is at a particular height that is smaller than a platform height threshold, which the controller 218 can use to indicate that the receptacle 110 includes at least a minimum empty volume for depositing additional items. The indicator 216 can use a first color (e.g., green) indicating that the receptacle includes at least a minimum empty volume for depositing additional items. FIG. 3E illustrates an example of three-dimensional cross-sectional views 300E with a critical receptacle fill level (being almost full) that provides limited empty volume within the receptacle 110 to enable deposition of additional items. In some implementations, if one or more of the sensor 202 detects that the telescoping bar 200 has a particular length that is equal or smaller than a threshold length (e.g., as illustrated in FIG. 3E), an alert can be generated by the controller 218 to indicate that the receptacle 110 reached a critical fill level and the receptacle 110 should be planned to be emptied within a particular period of time. The indicator 216 can use a second color (e.g., orange or yellow) indicating that the receptacle includes limited storage volume for depositing additional items. FIG. 3F illustrates an example of three-dimensional cross-sectional views 300F with a maximum receptacle fill level (being completely full) that provides insufficient empty volume within the receptacle 110 to enable deposition of additional items. In some implementations, if the sensor 202 detects that the telescoping bar 200 has a particular length that is equal or smaller than a second threshold length (e.g., as illustrated in FIG. 3F), an alert can be generated by the controller 218 to indicate that the receptacle 110 reached a maximum fill level (being full and unusable) and the receptacle 110 should be prioritized to be emptied within a particular period of time. The indicator 216 can use third color (e.g., red) indicating that the receptacle is full and includes insufficient empty volume for depositing additional items. More details about the process of detecting the fill level and alert generation are provided with reference to FIG. 5.

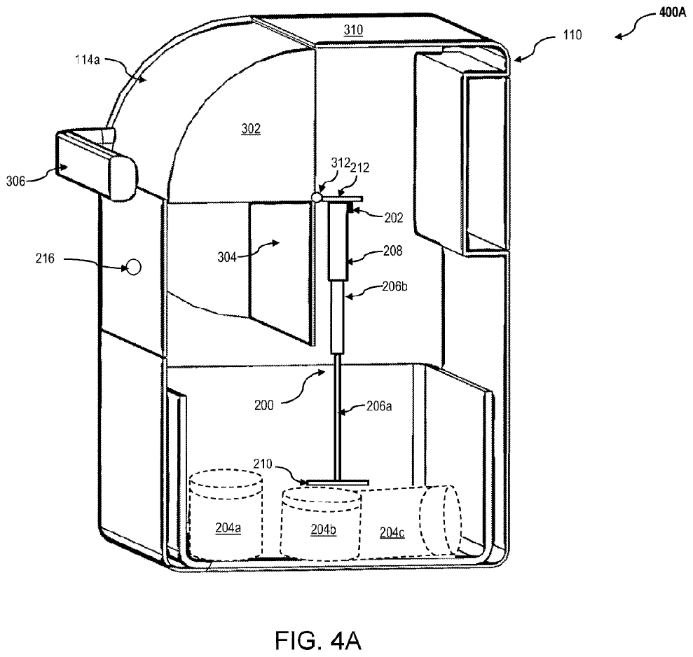

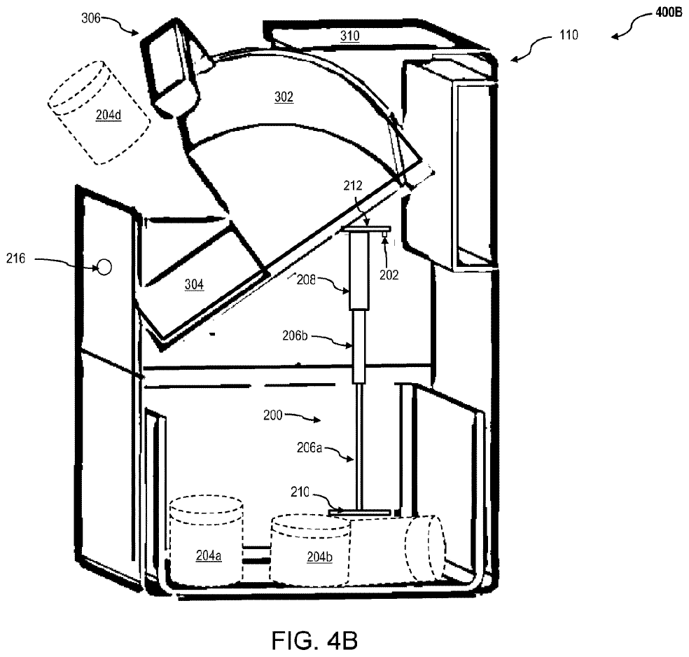

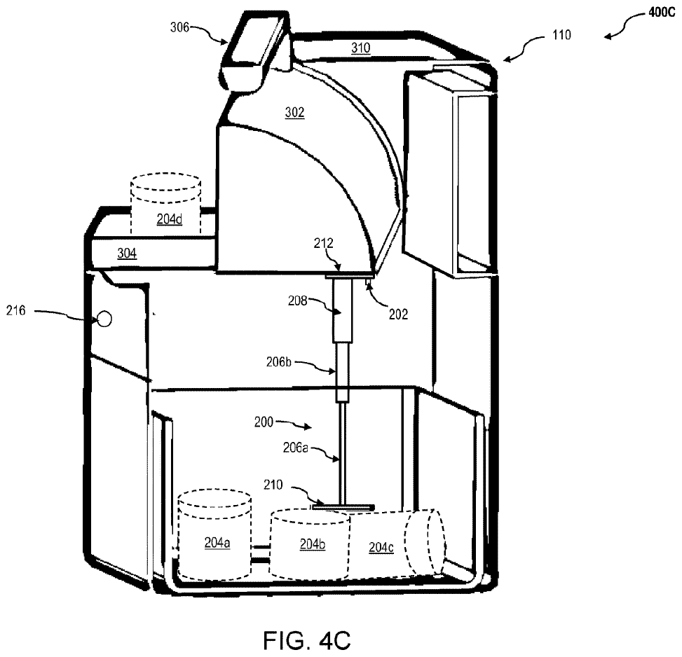

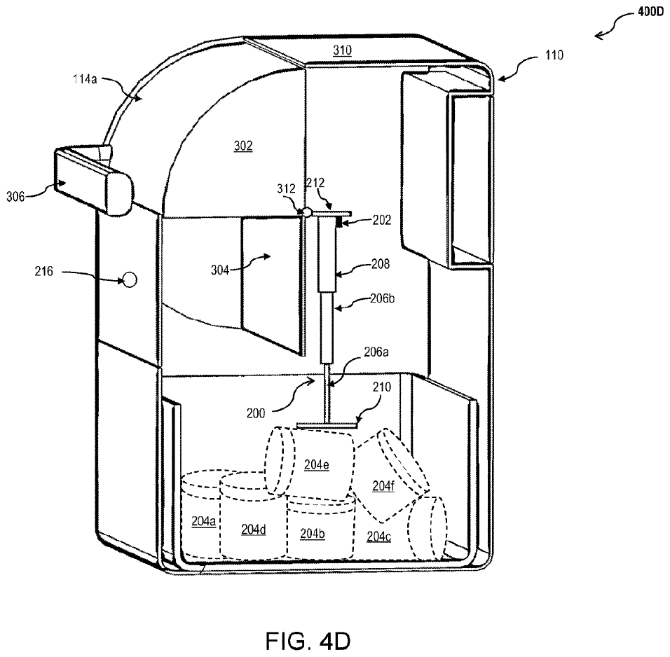

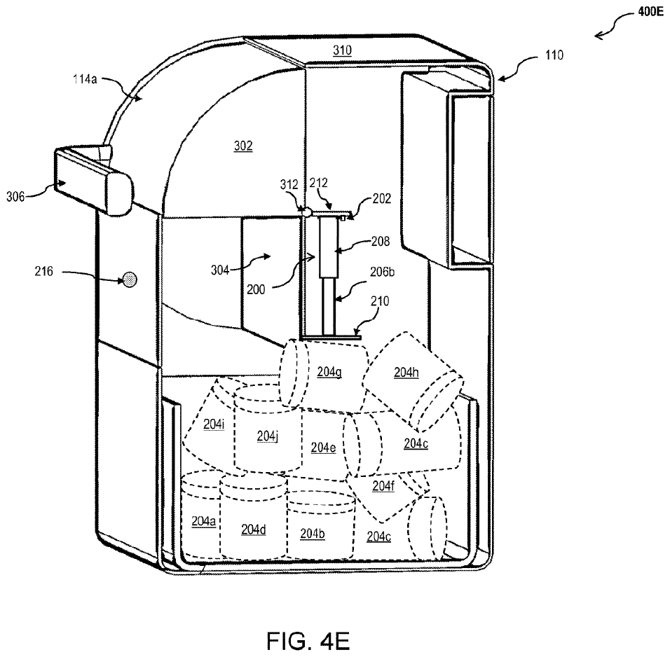

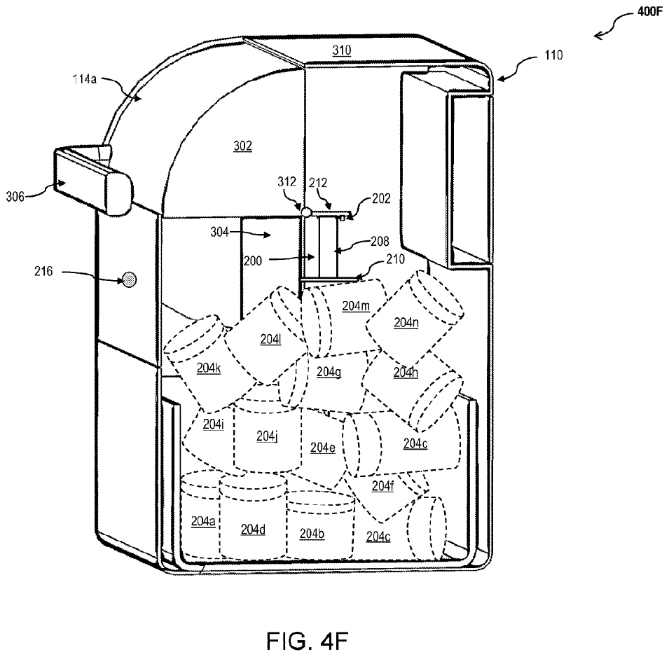

FIGS. 4A-4F illustrate another example of a length adjustment mechanism configured to adjust a length of the bar 200 in response to items being deposited in the receptacle 110, wherein the bar is extended such that the platform 210 is in contact with a bottom surface of the receptacle 110 or one or more top items deposited within the receptacle 110.

FIG. 4A illustrates a first length of the bar 200 corresponding to a first amount of items 202a-202c deposited in the receptacle 110. The first length of the bar 200 can include a first variable length section 206a that is partly retracted and the second variable length section 206b of the bar 200 that is fully extended, such that the platform 210 is in contact with an item 204b deposited in the receptacle 110. The sensor 202 can detect the position of the platform 210 indicating that the first variable length section 206a is partly retracted and the second variable length section 206b of the bar 200 is fully extended, corresponding to a partly filled (e.g., 15% filled) receptacle 110. FIGS. 4B and 4C illustrate the bar 200 maintaining its vertical orientation while the entry mechanism 114 is being opened for deposition of additional items into the receptacle 110.

FIGS. 4C to 4D illustrate an increasing amount of items from the first amount of items 202a-202c to a second amount of items 202a-202f. FIG. 4D illustrates the bar 200 having a second length corresponding to the second amount of items 202a-202f, being shorter than the first length corresponding to the first amount of items 202a-202c. FIG. 4D illustrates the first variable length section 206a as being partly retracted and the second variable length section 206b of the bar 200 as being fully extended, such that the platform 210 is in contact with a top located item 204e deposited in the receptacle 110. The sensor 202 can detect the position of the platform 210 indicating that the first variable length section 206a is partly retracted and the second variable length section 206b of the bar 200 is fully extended, corresponding to a partly filled (e.g., 30% filled) receptacle 110.

FIGS. 4D to 4E illustrate an increasing amount of items from deposited in the receptacle 110 from the second amount of items 202a-202f to a third amount of items 202a-202j. FIG. 4E illustrates the bar 200 having a third length corresponding to the third amount of items 202a-202j being shorter than the second length corresponding to the second amount of items 202a-202f. FIG. 4E illustrates the first variable length section 206a as being fully retracted and the second variable length section 206b of the bar 200 fully extended, such that the platform 210 is in contact with a top located item 204q deposited in the receptacle 110. The sensor 202 can detect the position of the platform 210 indicating that the first variable length section 206a is fully retracted and the second variable length section 206b of the bar 200 is fully or partly extended, corresponding to a partly filled (e.g., 70% filled) receptacle 110.

FIGS. 4E to 4F illustrate an increasing amount of items from deposited in the receptacle 110 from the third amount of items 202a-202j to a fourth amount of items 202a-202n. FIG. 4F illustrates the bar 200 having a fourth length corresponding to the fourth amount of items 202a-202n being shorter than the third length corresponding to the third amount of items 202a-202j. FIG. 4F illustrates the first and second variable length sections 206a, 206b as being fully retracted, such that the platform 210 is in contact with a top located item 204n deposited in the receptacle 110. The sensor 202 can detect the position of the platform 210 indicating that the variable length sections 206a, 206b are fully retracted, corresponding to a maximum fill level of the receptacle 110.

FIGS. 4A-4D illustrate examples of three-dimensional cross-sectional views 400A-400D with different receptacle fill levels that provide at least a minimum empty volume within the receptacle 110 to enable deposition of additional items. For the examples illustrated in FIGS. 4A-4E the sensor 202 can detect that the telescoping bar 200 has a particular length that is greater than a threshold length and/or the platform 210 is at a particular height that is smaller than a platform height threshold, which the controller 218 can use to indicate that the receptacle 110 includes at least a minimum empty volume for depositing additional items. The indicator 216 can use a first color (e.g., green) indicating that the receptacle includes at least a minimum empty volume for depositing additional items. FIG. 4E illustrates an example of three-dimensional cross-sectional views 400E with a critical receptacle fill level (being almost full) that provides limited empty volume within the receptacle 110 to enable deposition of additional items. In some implementations, if one or more of the sensor 202 detects that the telescoping bar 200 has a particular length that is equal or smaller than a threshold length (e.g., as illustrated in FIG. 4E), an alert can be generated by the controller 218 to indicate that the receptacle 110 reached a critical fill level and the receptacle 110 should be planned to be emptied within a particular period of time. The indicator 216 can use a second color (e.g., orange or yellow) indicating that the receptacle includes limited storage volume for depositing additional items. FIG. 4F illustrates an example of three-dimensional cross-sectional views 400F with a maximum receptacle fill level (being completely full) that provides insufficient empty volume within the receptacle 110 to enable deposition of additional items. In some implementations, if the sensor 202 detects that the telescoping bar 200 has a particular length that is equal or smaller than a second threshold length (e.g., as illustrated in FIG. 4F), an alert can be generated by the controller 218 to indicate that the receptacle 110 reached a maximum fill level (being full and unusable) and the receptacle 110 should be prioritized to be emptied within a particular period of time. The indicator 216 can use third color (e.g., red) indicating that the receptacle is full and includes insufficient empty volume for depositing additional items. More details about the process of detecting the fill level and alert generation are provided with reference to FIG. 5.

FIG. 5 depicts a flowchart illustrating a process 500 for determining a fill level of a receptacle, consistent with implementations of the current subject matter. The process 500 may be implemented by one or more of the specifically configured devices described with reference to FIGS. 1-3.

At 502, a first fill level of one or more receptacles (e.g., receptacle 110 described with reference to FIGS. 1-3) of a depositing system (e.g., depositing systems 102A, 102B described with reference to FIGS. 1-3) is determined. In some implementations, the first fill level of the receptacle is determined by retrieving a previously stored value from a database (e.g., database 109 described with reference to FIG. 1). In some implementations, the first fill level of the receptacle is determined in real time by activating a sensor (e.g., sensor 202 described with reference to FIGS. 2 and 3A-3F and 4A-4F) to generate a signal indicative of a length of a bar (e.g., bar 200 described with reference to FIGS. 2 and 3A-3F and 4A-4F), such as a location (height) of a platform (e.g., platform 210 described with reference to FIGS. 2 and 3A-3F and 4A-4F) attached to a distal end of the bar. The signal, received from the sensor, can be processed to determine a fill level of the receptacle. For example, the signal, received from the sensor, can be processed, by a fill level tracking device (e.g., fill level tracking device 112A, 112B described with reference to FIGS. 1 and 2) to determine the fill level of the receptacle. In some implementations, the first fill level of the receptacle is determined at set time intervals or in conjunction with an event of the depositing system, such as a restart event or a user authentication event. For example, a depositing system can authenticate a user of the depositing system. In some implementations, user authentication includes processing a user input including a username and password, scanning a user identification card using the camera or the sensor, scanning a biometric feature of the user using the camera or the sensor or any combination thereof. In some implementations, the user authentication event can include a user input including a request to deposit one or more items in a receptacle of the depositing system. In response to receiving the request to deposit one or more items in a receptacle of the depositing system, the fill level tracking device can compare the determined first fill level of the receptacle to a threshold fill level of the receptacle to determine that the first fill level of the receptacle is below the (critical) threshold fill level of the receptacle.

At 504, in response to successfully determining that the first fill level of the receptacle is below the (critical) threshold fill level of the receptacle, an item identifier is received, by the depositing system, from one or more sensing devices (e.g., sensing devices 116, 118 described with reference to FIGS. 1 and 2). The received item identifier can be matched to an item type classifying the item based on set classifications (e.g., controlled items, non-control items, critical expiration items, liquid or solid items, or special handling items). The item type can be used to determine a receptacle that can be used to deposit the identified item. For example, a receptacle can be selected from a set of available receptacles with a current fill level that is below a critical fill level threshold. For example, if the current fill level of the receptacle is below a set threshold (e.g., 90% of total fill level of the receptacle), the receptacle is identified as being available for depositing additional items of an identified type.

At 506, if the receptacle is identified as being available for depositing additional items, an entry mechanism (e.g., entry point 114a described with reference to FIGS. 1-3) can be unlocked to configure the entry mechanism to be openable to enable the (authenticated) user to deposit the identified items in the receptacle. In some implementations, a user interface of the depositing system (e.g., user interface 113 described with reference to FIGS. 1 and 2), can generate a visual and/or audio command for the user to deposit the item(s). The entry mechanism can be opened (in an unlocked state) to enable deposition of items on an item receiver (barrier) of the entry mechanism that block an access to an inner space of the receptacle, from where the item is dropped within the receptacle at closure of the entry mechanism. The item can drop within the receptacle in a manner that triggers an adjustment of an adjustable feature (length) of the bar that is monitored to derive the change in the fill level of the receptacle. In some implementations, in response to determining that the entry mechanism is being activated (opened) the bar can be fully retracted to enable the items to be deposited at a bottom of the receptacle without interfering with the bar and after the entry mechanism is closed, the bar can be released so that the platform attached to its distal edge rests on a topmost item deposited within the receptacle. The retraction may be mechanical based on a force applied to the door. For example, a handle may be turned to allow entry. Turning the handle may exert a force on the bar sufficient to retract the bar (e.g., shorten the length of the bar). In some implementations, the retraction may be electromechanical. For example, a sensor may detect a change in state for the entry mechanism (or hinge) and activate a bar retraction element. The bar retraction element may be or include a motor, a magnet, a vacuum, or similar element.

At 508, a signal indicative of a second fill level can be received from a sensor. For example, the sensor can detect that items were deposited in the receptacle and a length of the bar has changed (e.g., a height of the platform changed to a new height value). The length change of a variable length bar can be indicative of a volume occupied by the deposited items. The sensors may transmit the detected signal indicative of the items being deposited in the receptacle, to the fill level tracking device coupled to the sensor.

At 510, the signal indicative of the items being deposited in the receptacle can be processed to determine a fill level of the receptacle. For example, the signal indicative of the items being deposited in the receptacle can be processed, by the fill level tracking device to determine the fill level of the receptacle. The length of the variable length bar as detected by the sensors can be converted, using a set conversion model to determine the fill level of the receptacle (after the items were deposited). For example, the measured length of the variable length bar can have a set mathematical relationship (that can be defined in a lookup table) with the remaining available volume in the receptacle for depositing additional items. In some implementations, the fill level of the receptacle can be determined as a volume unit, as a height unit, and/or as a percentage of the receptacle volume available to deposit items without interfering with the entry mechanism.

At 512, the fill level of the receptacle is compared to one or more thresholds to determine if the receptacle is full (e.g., fill level greater than 95%) or critically filled (e.g., fill level greater than 75%). At 514, a receptacle fill level can be displayed. The fill level can be displayed by an interface of the depositing system, and/or an interface of the user device. For example, the receptacle status can be updated based on the current fill level and the receptacle status is transmitted to an indicator (e.g., indicator 216, described with reference to FIGS. 1-3), to illustrate a fill status of the receptacle. In some implementations, the indicator indicates the fill status of the receptacle using a color code that can be visible for a user of the depositing system. In some implementations, the fill level tracking device transmits an alert based on the updated fill status of the receptacle, such as to a display of the depositing system (e.g., the input user interface 113). The alert may include a visual, audio, audiovisual, tactile, and/or the like, indicator that indicates the fill status of the receptacle.

At 516, in response to determining that the fill level of the receptacle exceeds a fill threshold (the receptacle if full), the fill level tracking device can transmit a request to a data processing system (e.g., the data processing system 106 described with reference to FIG. 1) and/or a user device (e.g., the user device 104 described with reference to FIG. 1) to empty the receptacle. For example, the fill status of the receptacle can be transmitted to a central computing system, such as data processing system 106, described with reference to FIG. 1, to enable management of receptacle emptying plan for the receptacle and one or more receptacles of a facility. At 518, in response to determining that the fill level of the receptacle exceeds a fill threshold (the receptacle if full), the fill level tracking device can transmit a signal for the entry mechanism to be locked to prevent additional items to be deposited in the receptacle before the receptacle is emptied. At 520, an emptying action of the receptacle can be detected, which enables the process 500 to be repeated.

The system for detection of a receptacle fill level including the fill level detection assembly described herein may accurately determine the receptacle fill level based on length detection of a variable length bar, which helps to improve control of deposition of items within receptacles and a receptacle emptying plan to prevent allowing receptacles to be filled until they cannot be used for deposition of additional items.

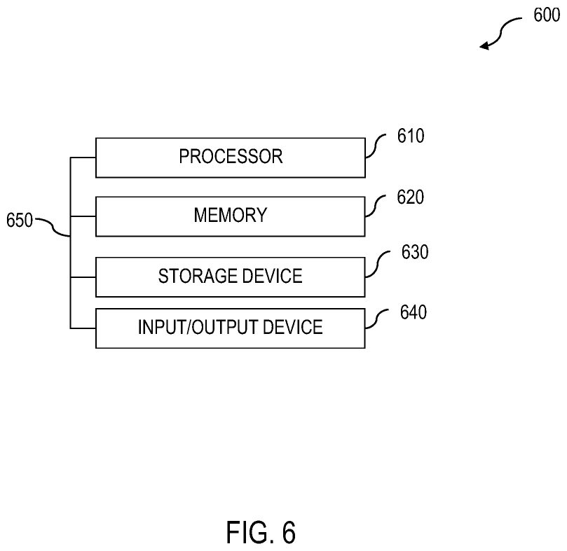

FIG. 6 depicts a block diagram illustrating a computing system 600 consistent with implementations of the current subject matter. Referring to FIGS. 1 and 6, the computing system 600 can be specifically configured for determining a fill level of a receptacle of a depositing system with a computing system, a display, and/or any components therein.

As shown in FIG. 6, the computing system 600 can include a processor 610, a memory 620, a storage device 630, and input/output devices 640. The processor 610, the memory 620, the storage device 630, and the input/output devices 640 can be interconnected via a system bus 650. The processor 610 is capable of processing instructions for execution within the computing system 600. Such executed instructions can be implemented by one or more components of, for example, the depositing system 102A, 102B. In some example implementations, the processor 610 can be a single-threaded processor. Alternatively, the processor 610 can be a multi-threaded processor. The processor 610 is capable of processing instructions stored in the memory 620 and/or on the storage device 630 to present graphical information for a user interface provided via the input/output device 640.

The memory 620 is a computer readable medium such as volatile or non-volatile that stores information within the computing system 600. The memory 620 can store data structures representing configuration object databases, for example. The storage device 630 is capable of providing persistent storage for the computing system 600. The storage device 630 can be a floppy disk device, a hard disk device, an optical disk device, or a tape device, or other suitable persistent storage means. The input/output device 640 provides input/output operations for the computing system 600. In some example implementations, the input/output device 640 includes a keyboard and/or pointing device. In various implementations, the input/output device 640 includes a display unit for displaying graphical user interfaces.

According to some example implementations, the input/output device 640 can provide input/output operations for a network device. For example, the input/output device 640 can include Ethernet ports or other networking ports to communicate with one or more wired and/or wireless networks (e.g., a local area network (LAN), a wide area network (WAN), the Internet).

In some example implementations, the computing system 600 can be used to execute various interactive computer software applications that can be used for organization, analysis and/or storage of data in various formats. Alternatively, the computing system 600 can be specifically configured to execute software applications. These applications can perform various fullness detection functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in specifically configured digital electronic circuitry, integrated circuitry, application-specific integrated circuit (ASIC), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C,” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

As used herein a “user interface” (also referred to as an interactive user interface, a graphical user interface or a user interface or UI) may refer to a network based interface including data fields and/or other control elements for receiving input signals or providing electronic information and/or for providing information to the user in response to any received input signals. Control elements may include dials, buttons, icons, selectable areas, or other perceivable indicia presented via the UI that, when interacted with (e.g., clicked, touched, selected, etc.), initiates an exchange of data for the device presenting the UI. A UI may be implemented in whole or in part using technologies such as hyper-text mark-up language (HTML), FLASH™, JAVA™, NET™, web services, or rich site summary (RSS). In some implementations, a UI may be included in a stand-alone client (for example, thick client, fat client) configured to communicate (e.g., send or receive data) in accordance with one or more of the aspects described. The communication may be to or from a medical device or server in communication therewith.

As used herein, the terms “determine” or “determining” encompass a wide variety of actions. For example, “determining” may include calculating, computing, processing, deriving, generating, obtaining, looking up (e.g., looking up in a table, a database or another data structure), ascertaining and the like via a hardware element without user intervention. Also, “determining” may include receiving (e.g., receiving information), accessing (e.g., accessing data in a memory) and the like via a hardware element without user intervention. “Determining” may include resolving, selecting, choosing, establishing, and the like via a hardware element without user intervention.

As used herein, the terms “provide” or “providing” encompass a wide variety of actions. For example, “providing” may include storing a value in a location of a storage device for subsequent retrieval, transmitting a value directly to the receptacle via at least one wired or wireless communication medium, transmitting or storing a reference to a value, and the like. “Providing” may also include encoding, decoding, encrypting, decrypting, validating, verifying, and the like via a hardware element.

As used herein, the term “message” encompasses a wide variety of formats for communicating (e.g., transmitting or receiving) information. A message may include a machine-readable aggregation of information such as an XML document, fixed field message, comma separated message, or the like. A message may, in some implementations, include a signal utilized to transmit one or more representations of the information. While recited in the singular, it will be understood that a message may be composed, transmitted, stored, received, etc. in multiple parts.

As user herein, the terms “correspond” or “corresponding” encompasses a structural, functional, quantitative and/or qualitative correlation or relationship between two or more objects, data sets, information and/or the like, preferably where the correspondence or relationship may be used to translate one or more of the two or more objects, data sets, information and/or the like so to appear to be the same or equal. Correspondence may be assessed using one or more of a threshold, a value range, fuzzy logic, pattern matching, a machine learning assessment model, or combinations thereof.

In some implementations, data generated or detected can be forwarded to a “remote” device or location, where “remote,” means a location or device other than the location or device at which the program is executed. For example, a remote location could be another location (e.g., office, lab, etc.) in the same city, another location in a different city, another location in a different state, another location in a different country, etc. As such, when one item is indicated as being “remote” from another, what is meant is that the two items can be in the same room but separated, or at least in different rooms or different buildings, and can be at least one mile, ten miles, or at least one hundred miles apart. “Communicating” information references transmitting the data representing that information as electrical signals over a suitable communication channel (e.g., a private or public network). “Forwarding” an item refers to any means of getting that item from one location to the next, whether by physically transporting that item or otherwise (where that is possible) and includes, at least in the case of data, physically transporting a medium carrying the data or communicating the data. Examples of communicating media include radio or infra-red transmission channels as well as a network connection to another computer or networked device, and the internet or including email transmissions and information recorded on websites and the like.

Further non-limiting aspects or implementations are set forth in the following numbered examples:
Example 1: An apparatus comprising: a housing; an entry point affixed to the housing; a bar, coupled by a hinge to an inner surface of the entry point, the bar comprising a platform at a distal edge of the bar, the platform being configured to come in contact with an item deposited in the housing; and a sensor configured to generate a signal indicative of a fill level of the housing based on the platform coming in contact with the item deposited in the housing.
Example 2: The apparatus of example 1, wherein the entry point comprises an item receiver configured to block an access to an interior of the housing, when the entry point is in an opened position, the item receiver being configured to release deposited items in the housing when the entry point is in a closed position.
Example 3: The apparatus of any one of the proceeding examples, wherein the hinge is configured to maintain the bar in a vertical position independent of a position of the entry point.
Example 4: The apparatus of any one of the proceeding examples, wherein the bar comprises a plurality of segments that can slide relative to each other to adjust a length of the bar relative to the fill level of the housing.
Example 5: The apparatus of any one of the proceeding examples, wherein the plurality of segments comprises a first segment having a first sliding resistance and a second segment having a second sliding resistance, the first sliding resistance being different from the second sliding resistance to enable sequential sliding of the plurality of segments.
Example 6: The apparatus of any one of the proceeding examples, wherein the bar comprises a spring configured to adjust the length of the bar, for the bar to apply substantially zero pressure on the item the platform is in contact with.
Example 7: The apparatus of any one of the proceeding examples, wherein the sensor is configured to detect a length of the bar based on the position of the platform.
Example 8: The apparatus of any one of the proceeding examples, wherein the sensor comprises an ultrasound sensor or an infrared sensor.
Example 9: The apparatus of any one of the proceeding examples, wherein the sensor is attached to a proximal end of the edge of the bar or to the hinge.
Example 10: The apparatus of any one of the proceeding examples, wherein the sensor is configured to generate a signal to block an opening of the entry point in response to detecting that the housing is full.
Example 11: A method of detecting a fill level of a bin, the method comprising: receiving, from a sensor, a first measurement of a first length of a telescoping bar coupled to an entry point of the bin; detecting, opening of the entry point of the bin, permitting one or more items to be deposited into the bin; receiving from the sensor, a second measurement of a second length of the bar being in contact with the one or more items deposited into the bin; and determining the fill level based at least in part on a comparison between the first measurement and the second measurement.
Example 12: The method of example 11, wherein the sensor is activated to measure a length of the bar in response to a trigger associated with the opening of the entry point.
Example 13: The method of any one of the proceeding examples, further comprising: determining that the fill level exceeds a threshold fill level; and preventing an opening of the entry point of the bin by activating an entry point lock.
Example 14: The method of any one of the proceeding examples, further comprising: transmitting a request to empty the bin.
Example 15: The method of any one of the proceeding examples, further comprising: determining an emptying of the bin; and deactivating the entry point lock.
Example 16: The method of any one of the proceeding examples, wherein the sensor comprises an ultrasound sensor or an infrared sensor.
Example 17: The method of any one of the proceeding examples, further comprising: processing the first measurement and the second measurement received from the sensor to determine a percentage of the fill level of the bin.
Example 18: The method of any one of the proceeding examples, further comprising: displaying the fill level of the bin.
Example 19: The method of any one of the proceeding examples, further comprising: receiving an identifier of the one or more items to be deposited into the bin; determining an estimated fill level of the bin based on the identifier of the one or more items; and adjusting the determined fill level of the bin based on the estimated fill level of the bin.
Example 20: The method of any one of the proceeding examples, further comprising: generating a signal to retract the bar in response to receiving any of the first measurement and the second measurement.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

1. An apparatus comprising:
a housing;
an entry point affixed to the housing;
a bar, coupled by a hinge to an inner surface of the entry point, the bar comprising a platform at a distal edge of the bar, the platform being configured to come in contact with an item deposited in the housing; and
a sensor configured to generate a signal indicative of a fill level of the housing based on the platform coming in contact with the item deposited in the housing.

2. The apparatus of claim 1, wherein the entry point comprises an item receiver configured to block an access to an interior of the housing, when the entry point is in an opened position, the item receiver being configured to release deposited items in the housing when the entry point is in a closed position.

3. The apparatus of claim 1, wherein the hinge is configured to maintain the bar in a vertical position independent of a position of the entry point.

4. The apparatus of claim 1, wherein the bar comprises a plurality of segments that can slide relative to each other to adjust a length of the bar relative to the fill level of the housing.

5. The apparatus of claim 3, wherein the plurality of segments comprises a first segment having a first sliding resistance and a second segment having a second sliding resistance, the first sliding resistance being different from the second sliding resistance to enable sequential sliding of the plurality of segments.

6. The apparatus of claim 4, wherein the bar comprises a spring configured to adjust the length of the bar, for the bar to apply substantially zero pressure on the item the platform is in contact with.

7. The apparatus of claim 6, wherein the sensor is configured to detect a length of the bar based on the position of the platform.

8. The apparatus of claim 7, wherein the sensor comprises an ultrasound sensor or an infrared sensor.

9. The apparatus of claim 1, wherein the sensor is attached to a proximal end of the edge of the bar or to the hinge.

10. The apparatus of claim 1, wherein the sensor is configured to generate a signal to block an opening of the entry point in response to detecting that the housing is full.

11. A method of detecting a fill level of a bin, the method comprising:
receiving, from a sensor, a first measurement of a first length of a telescoping bar coupled to an entry point of the bin;
detecting, opening of the entry point of the bin, permitting one or more items to be deposited into the bin;
receiving from the sensor, a second measurement of a second length of the bar being in contact with the one or more items deposited into the bin; and
determining the fill level based at least in part on a comparison between the first measurement and the second measurement.

12. The method of claim 11, wherein the sensor is activated to measure a length of the bar in response to a trigger associated with the opening of the entry point.

13. The method of claim 11, further comprising:
determining that the fill level exceeds a threshold fill level; and
preventing an opening of the entry point of the bin by activating an entry point lock.

14. The method of claim 13, further comprising:
transmitting a request to empty the bin.

15. The method of claim 14, further comprising:
determining an emptying of the bin; and
deactivating the entry point lock.

16. The method of claim 11, wherein the sensor comprises an ultrasound sensor or an infrared sensor.

17. The method of claim 11, further comprising:
processing the first measurement and the second measurement received from the sensor to determine a percentage of the fill level of the bin.

18. The method of claim 11, further comprising:
displaying the fill level of the bin.

19. The method of claim 11, further comprising:
receiving an identifier of the one or more items to be deposited into the bin;
determining an estimated fill level of the bin based on the identifier of the one or more items; and
adjusting the determined fill level of the bin based on the estimated fill level of the bin.

20. The method of claim 11, further comprising:
generating a signal to retract the bar in response to receiving any of the first measurement and the second measurement.
